(19) United States
(12) Patent Application Publication
(10) Pub. No.: US 2020/0139970 A1
(43) Pub. Date: May 7, 2020

(54) METHOD AND ARRANGEMENT FOR SETTING A TARGET DECELERATION FOR A TRANSPORTATION VEHICLE

(71) Applicant: VOLKSWAGEN AKTIENGESELLSCHAFT, Wolfsburg (DE)

(72) Inventor: Benjamin DUNCAN, Berlin (DE)

(21) Appl. No.: 16/674,188

(22) Filed: Nov. 5, 2019

(30) Foreign Application Priority Data
Nov. 5, 2018 (DE) 10 2018 218 844.0

(51) Int. Cl. B60W 30/18; B60W 10/04

(52) U.S. Cl. CPC B60W 30/181; B60W 10/04; B60W 2720/106; B60W 2510/18; B60W 2550/308

(57) ABSTRACT

A method for defining a target deceleration for an ego transportation vehicle including determining at least one motional variable of a transportation vehicle ahead; determining a braking time and a braking distance based on the motional variable which the transportation vehicle ahead respectively needs to come to a standstill; determining for the ego transportation vehicle a braking time that is needed to come to a standstill at the latest at the same position as the transportation vehicle ahead when the transportation vehicle ahead has travelled the braking distance; defining a target deceleration for the ego transportation vehicle based on a relationship of the braking times of the transportation vehicle ahead and the ego transportation vehicle. An apparatus for defining a target deceleration for an ego transportation vehicle and a transportation vehicle having such an apparatus.

### PRIORITY CLAIM

This patent application claims priority to German Patent Application No. 10 2018 218 844.0, filed 5 Nov. 2018, the disclosure of which is incorporated herein by reference in its entirety.

### SUMMARY

Illustrative embodiments relate to a method and an apparatus for defining a target deceleration for an ego transportation vehicle.

### BRIEF DESCRIPTION OF THE DRAWINGS

In the following, disclosed embodiments are illustrated with the aid of the attached schematic figures. Similar features or features with similar functions can be provided here with the same reference numerals. The figures show:

FIG. 1 is a representation of a disclosed apparatus according to a first embodiment which executes the disclosed method;

FIG. 2 is a representation of a schematic sequence of a disclosed method executed by the apparatus shown in FIG. 1;

FIG. 3 is a course of deceleration achievable with the apparatus shown in FIG. 1; and

FIG. 4 is a course of deceleration achievable according to the prior art.

### DETAILED DESCRIPTION

By the term “ego transportation vehicle”, a transportation vehicle currently under consideration is understood, to which the measures depicted here are applied and for which the target deceleration is defined. A distinction is to be made between this ego transportation vehicle and other transportation vehicles in the area of the disclosed ego transportation vehicle with which collisions and, in particular, rear-ending accidents are to be avoided.

Assisting drivers of an ego transportation vehicle by emergency braking functions is known. The emergency braking functions can function autonomously from the driver or in addition to a braking force exerted by the driver and generally serve the purpose of avoiding collisions with transportation vehicles ahead. By the term “ahead” here, transportation vehicles can be understood that are, when viewed in relation to the direction of motion of the ego transportation vehicle, are arranged in front of the latter or will presumably be arranged in front of the latter in the near future. For example, these transportation vehicles can travel in the same direction of motion or in a direction that crosses the direction of motion of the ego transportation vehicle. In the latter case, they can reach locations or already have reached locations that lie ahead when viewed from the ego transportation vehicle. Alternatively, the transportation vehicles can also be stationary temporarily or in a sustained manner, in particular, in a position lying ahead when viewed from the ego transportation vehicle and in relation to its direction of motion.

In this context, DE 10 2012 002 695 A1 teaches different criteria to evaluate whether the emergency braking function should be activated. Furthermore, necessary decelerations are detected (also called avoidance accelerations), for example, based on the assumption that, for an avoidance of a collision, a speed of an ego transportation vehicle in relation to a transportation vehicle ahead must become zero.

The use of different avoidance accelerations according to the current driving situation is known from the specialist literature. Specifically, a distinction is made between the case of an obstacle ahead decelerating in a constant manner and an obstacle braking to a standstill. In illustrative terms, a distinction is to be made whether the transportation vehicle ahead is likely to be hit by the ego transportation vehicle when it is still moving or when it is already at a standstill. For this purpose, motional variables of the ego transportation vehicle can be detected in a known manner, for example, by its own speed sensors, as well as motional variables of the transportation vehicle ahead, for example, by ambient sensors and, in particular, distance sensors. Depending on the assumed scenario, different target decelerations are selected and, for example, implemented by a and brake actuator that can be actuated independently of the driver, wherein the target decelerations are designed so that the assumed collision scenario is presumably avoided.

It should be noted here that the target decelerations also meet road safety requirements and, in particular, driving stability requirements and thus differ from a direct activation of a maximum braking force, which is generally undesirable. A distinction is further made therefore according to the assumed collision scenarios, as, in the case of the transportation vehicle braking to a standstill, the latter already generates a relatively large deceleration itself and consequently one's own braking action can possibly be less intense.

To determine which of the collision scenarios is presumably accurate, the so-called eTTC (enhanced Time To Collision) discussed in the aforementioned specialist literature is calculated. This variable considers the acceleration or deceleration of the transportation vehicle ahead.

It can be examined with the eTTC whether the transportation vehicle ahead reaches a standstill before it is hit by the ego transportation vehicle. More specifically, it can be estimated how long the transportation vehicle ahead would need for a braking action to a standstill and, if the corresponding time value is greater than the eTTC, it will be hit in a still moving state and, if the time value is smaller than the eTTC, it will be hit in a stationary state. Depending on the determined collision scenario, the target decelerations are then selected, which are determined using previously stored and collision-scenario-specific formulae.

However, it has proven problematic that, with the approach used to date, it must be estimated at the outset which of the collision scenarios is relevant (assumed collision with a moving or with a stationary transportation vehicle). For example, it can occur that one of these scenarios is initially assumed and the associated target deceleration is selected, but that this selection proves to be inaccurate due to the motional circumstances unfolding during the braking action and it is consequently necessary to switch to another target deceleration. Such a jump between target decelerations is undesirable from the point of view of the driver and also represents a safety risk, in particular, when a target deceleration was initially chosen that resulted in a braking action that is too weak. The opposite case is also conceivable in which an unnecessarily high deceleration is set and, by this means, the risk of collision, for example, with following traffic is increased or the triggering of emergency braking functions that are not actually necessary is caused.

There is thus a need to improve the setting of an emergency braking function for a transportation vehicle.

The disclosed embodiments provide a method, an apparatus, and a transportation vehicle.

An essential idea is to provide improved options for the target deceleration to be implemented. By this means, subsequent switches between different pre-determined target decelerations become less likely or are avoided entirely. This improves the safety and also the driving and braking behavior of the transportation vehicle from the point of view of the driver.

More specifically, the disclosed embodiments propose to determine motional variables of a transportation vehicle ahead and to ascertain therefrom a braking time and a braking distance that would be needed to reach a standstill. The position (standstill position) at which the transportation vehicle ahead would come to a standstill at the latest can obviously also be ascertained from the braking distance. On this basis, it is possible to ascertain for the ego transportation vehicle the braking time that it needs to come to a standstill at the same position. By this means, a collision can presumably be avoided. This is ascribable to a mathematical assumption in accordance with which the transportation vehicles are considered as points. Furthermore, the risk of collision can be further reduced by the subsequent provision of tolerance or buffer factors.

The determined braking times can subsequently be compared or related to one another. It can be examined whether the braking time of the ego transportation vehicle to a full stop at the standstill position is less than that of the transportation vehicle ahead. If this is the case, the ego transportation vehicle will presumably hit the transportation vehicle ahead while the latter is still moving and a pre-determined target deceleration for this scenario can be selected. If, on the other hand, the braking time of the ego transportation vehicle to a full stop at the standstill position is greater than that of the transportation vehicle ahead, the ego transportation vehicle will reach the standstill position before the transportation vehicle ahead. A different pre-determined target deceleration would then optionally be selected.

A difference to the approach used to date is evident in the assumption of an actual braking of the ego transportation vehicle and in the consideration of the potential reaching of a state that avoids the collision (standstill position). One can thus speak of avoidance points in time and avoidance braking distances that are considered in accordance with the disclosure.

Based on such considerations, a suitable target deceleration can be chosen from the outset, i.e., at the beginning of an assisted or autonomous emergency braking operation. It has been shown that the proposed selection of the target deceleration carried out using a relationship of the braking times is more accurate than the approaches used to date and, in particular, that a switching between different target decelerations in the course of the braking operation is less likely or can also be avoided completely.

In detail, a method for defining a target deceleration for an ego transportation vehicle is proposed, wherein the method includes:

determining at least one motional variable of a transportation vehicle ahead;

determining a braking time and a braking distance based on the motional variable which the transportation vehicle ahead would respectively need to come to a standstill;

determining for the ego transportation vehicle a braking time that would be required to come to a standstill at the latest at the same position as the transportation vehicle ahead when the latter has travelled the braking distance;

defining a target deceleration for the ego transportation vehicle based on a relationship of the braking times of the transportation vehicle ahead and the ego transportation vehicle.

The motional variable can be a positional datum (e.g., relating to an absolute position or a distance or position relative to the ego transportation vehicle). Determining the motional variable can be understood to mean a measurement. From the positional datum or its alteration over time, further motional variables such as speed or an acceleration of the transportation vehicle ahead can then also be calculated. This speed and/or acceleration can however also be captured by measurement technology. Optionally, all or at least two of these motional variables (positional datum, speed, acceleration) are determined and measured.

To summarize, any motional variable can be determined by measurement technology or, expressed differently, based on a capture of the movement of the transportation vehicle ahead with sensors. Optionally, at least one positional datum described in the foregoing is captured by measurement technology and further motional variables (e.g., speed and/or acceleration) are calculated therefrom.

For this purpose, the ego transportation vehicle (or the apparatus described in the following) can comprise ambient sensors which capture a movement of the transportation vehicle ahead. These can be, for example, distance sensors and/or a radar, lidar or ultrasound sensor. It is obvious that, from a motional variable captured by measurement technology, further motional variables can also be determined and calculated. An acceleration can be calculated from a speed and/or (relative) position captured by measurement technology.

In the framework of the present disclosure, an acceleration can also include decelerations, which are negative accelerations and correspond to a braking action of the corresponding transportation vehicle.

The braking time can be determined by making a quotient from a determined speed of the transportation vehicle ahead and its deceleration (in particular, its absolute deceleration aAbsObj, optionally multiplied by −1). As an example, reference is made to the following equation (1) in which the braking time of the transportation vehicle ahead is indicated as Object_Time_to Stillstand and vObj is the speed of the transportation vehicle:

$$Object\_Time \_To \_Stillstand = \frac{{v}_{obj}}{- {a}_{AbsObj}} . \qquad ( 1 )$$

The braking distance (Object_Distance_to Stillstand) can be established by making the quotient from the square of the determined speed of the transportation vehicle ahead and its acceleration multiplied by two. As an example, reference is made to the following equation (2) in which the variables are defined as in the foregoing:

$$Object\_Distance \_To \_Stillstand = - \frac{{v}_{Obj}^{2}}{2 {α}_{AbsObj}} . \qquad ( 2 )$$

To determine the braking time of the ego transportation vehicle for it to come to a standstill at the latest at the same position as the transportation vehicle ahead, the braking distance of the ego transportation vehicle (Ego_Distance_to_Stillstand) to precisely this position can first be determined. This is composed of the relative distance (dx_rel) to the transportation vehicle ahead and the braking distance of the transportation vehicle ahead (Object_Distance_to Stillstand), see, for example, the following equation (3):

Ego_Distance_to_Stillstand=Object_Distance_to Stillstand+dx_rel (3).

This equation expresses that a collision is considered avoidable when the ego transportation vehicle comes to a standstill at the same position as the transportation vehicle ahead. Safety buffers can be taken into account here, for example, when it is to be assumed that, due to the behavior of the driver or the characteristics of the system, a maximum braking force does not immediately take hold. In this case, for example, in equation (3), a negative distance can be taken into account within which it is assumed that a sufficient braking force has not yet taken hold and that a maximum braking force has not yet taken hold. For example, the relative distance dx_rel could be reduced by a corresponding distance.

If the braking distance of the ego transportation vehicle is known, its braking time until the reaching of the position depicted in the foregoing can also be ascertained on this basis, namely by making the quotient of the (optionally doubled) braking distance of the ego transportation vehicle and the speed of the ego transportation vehicle:

$$Ego\_Time \_To \_Stillstand = \frac{2 \cdot Ego\_Distance \_Travel \_To \_Stillstand}{{v}_{Ego}} . \qquad ( 4 )$$

The target deceleration can be a variable that is used as or for generating a control variable for a brake actuator. The brake actuator can be adapted to implement the deceleration and, for example, can be configured as a brake pressure generating device that can be actuated independently of the driver.

The relationship of the braking times can be a quotient, a difference or a general comparison and a larger/smaller comparison of the braking times.

According to an exemplary embodiment, when the braking time of the transportation vehicle ahead is greater than that of the ego transportation vehicle, a first (optionally pre-defined) target deceleration is selected. This can differ from a second (optionally pre-defined) target deceleration described in the following. It can be provided that at least a first and a second target deceleration are stored as pre-defined target decelerations and a selection is made between the two depending on the current conditions.

A formula and/or a rule for the deceleration can generally define a target deceleration and indicate a target deceleration function. Consequently, it can also be provided that a target deceleration in the sense of a target deceleration function to be used is selected and current values with respect to the motional variables enumerated above are then inserted into the same.

The operation of the definition of a target deceleration can thus relate to the selection or definition of a target deceleration function to be used and optionally also to the insertion of values in the same (for example, values for the motional variables listed above) to determine a target deceleration value or value pattern to be applied.

It can be further provided that the first target deceleration relates to a collision scenario between the ego transportation vehicle and a still moving transportation vehicle ahead. The target deceleration can be chosen so that a collision with the transportation vehicle is avoidable based on the assumption that the latter (without the performance of decelerations, i.e., on the condition that the current motional variables are retained) would still be moving in the event of a collision. When defining the target deceleration, it can consequently be taken into account that a certain (active) movement of the transportation vehicle ahead in relation to the ego transportation vehicle exists and/or is maintained.

The first target deceleration can be chosen as follows in this context:

$${D}_{req , D} = {D}_{obs} + \frac{{v}_{diff}^{2}}{2 d} , \qquad ( 5 )$$

where D_{req,D} is the target deceleration to be set, D_{obs} is the absolute deceleration of the transportation vehicle ahead, v_{diff} is the difference in speed between the ego transportation vehicle and the transportation vehicle ahead and d is the distance between the ego transportation vehicle in the transportation vehicle ahead.

According to a further disclosed embodiment, when the braking time of the transportation vehicle ahead is smaller than that of the ego transportation vehicle, a second target deceleration is selected. In this case, it should be assumed that the transportation vehicle ahead will come to a standstill faster than the ego transportation vehicle and will thus reach the standstill position (i.e., the position that would be consistent with a collision avoidance) before the ego transportation vehicle. In this context, it can consequently be further provided that the second target deceleration relates to a collision scenario between the ego transportation vehicle and a stationary transportation vehicle ahead.

The following can be chosen as the second target deceleration:

$${D}_{req , stop} = \frac{{v}_{sub}^{2}}{2 ( d + \frac{{v}_{obs}^{2}}{2 {D}_{obs}} )} , \qquad ( 6 )$$

wherein D_{req,stop} is the target deceleration to be set, v_{sub} is the speed of the ego transportation vehicle, v_{obs} is the speed of the transportation vehicle ahead and d is the distance between the ego transportation vehicle and the transportation vehicle ahead.

Disclosed embodiments further relate to an apparatus for defining a target deceleration for an ego transportation vehicle, wherein the apparatus comprises:

a motional variable determination device adapted to determine at least one motional variable of the transportation vehicle ahead;

a target deceleration definition device adapted to determine the following:

a braking time and a braking distance based on the motional variable which the transportation vehicle ahead would respectively need to come to a standstill; and

a braking time for the ego transportation vehicle that would be needed to come to a standstill at the latest at the same position as the transportation vehicle ahead when the latter has travelled the braking distance;

and wherein the target deceleration definition device is further adapted to define a target deceleration for the ego transportation vehicle based on a relationship of the braking times of the transportation vehicle ahead and the ego transportation vehicle.

The apparatus can generally comprise any further feature and any further function to provide all of the effects, interactions and operational states described in the foregoing and in the following. The apparatus can also comprise any features described in connection with the method. Any embodiments described in connection with the method can also apply to the analogous apparatus features. It can further generally be provided that the apparatus is adapted to execute a method in accordance with any of the embodiments set out in the foregoing or in the following.

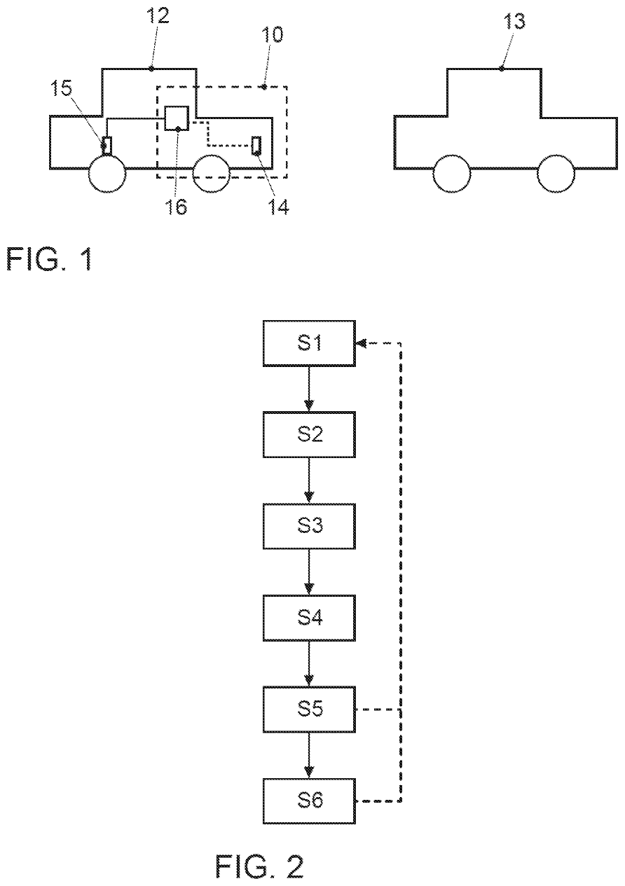

FIG. 1 shows schematically an apparatus 10 according to a first disclosed embodiment which executes the disclosed method. The apparatus 10 is comprised by a schematically indicated transportation vehicle (ego transportation vehicle) 12. A direction of motion of the transportation vehicle 12 in FIG. 1 is from left to right.

The ego transportation vehicle 12 comprises a plurality of motional variable determination devices 14, such as ambient sensors, of which merely one is indicated schematically. This can be, for example, a radar distance sensor, although further motional variables of the transportation vehicle ahead 13, in particular, its speed and acceleration, can also be determined from the alterations (over time) in the distance values to a transportation vehicle ahead 13 measured by the sensor.

The ego transportation vehicle 12 further comprises a target deceleration definition device 16. This is configured as a control unit of the ego transportation vehicle 12 or is integrated in an existing control unit. In the illustrated example, the target deceleration definition device 16 receives from the motional variable determination device 14 determined signals relating to the motional variables of the transportation vehicle ahead 13. The target deceleration definition device 16 is further connected with a brake actuator, not illustrated separately, which is adapted to decelerate the transportation vehicle 12 in accordance with the stipulations of the control signals generated by the target deceleration definition device 16. The target deceleration definition device 16 additionally receives signals relating to the motional variables of the ego transportation vehicle 12, for example, from a conventional speed sensor 15, which can be, for example, an ABS wheel speed sensor.

FIG. 2 shows a sequence of a disclosed method that can be implemented with the apparatus 10 from FIG. 1. In an operation at 51, a distance (i.e., a positional datum, in particular, in relation to the ego transportation vehicle 12), a speed and an acceleration of the transportation vehicle ahead 13 are determined by the target deceleration definition device 16 as motional variables. For example, values of this variable can be received from the ambient sensors of the transportation vehicle 13. At this point in time, according to conventional approaches and, for example, approaches described in the specialist literature cited above, it has already been determined that a target deceleration should be set. In a manner known per se, the target deceleration can however also be determined in a continuous state, for example, to act as a measure for the criticality of a current driving situation, independently of whether the braking-assistance or even emergency-braking functions have actually been activated. Beginning with operation at 51, it shall be determined with the disclosed method which target deceleration is to be set.

In an operation at S2, the braking time of the transportation vehicle ahead 13 is determined by the determined motional variables and the equation (1) indicated in the foregoing. The equation (1) indicated in the foregoing is used for this purpose.

In an operation at S3, the braking distance of the transportation vehicle ahead 13 is determined by the determined motional variables and the equation (2) indicated in the foregoing. The equation (2) indicated in the foregoing is used for this purpose.

In an operation at S4, the braking distance of the ego transportation vehicle 12 is determined by the relative distance between the transportation vehicles 12, 13, the determined braking distance of the transportation vehicle ahead 13 and the equation (3) indicated in the foregoing.

Subsequently, based on the speed of the ego transportation vehicle 12 and the result of operation at S4, the braking time of the ego transportation vehicle 12 is determined in operation at S5.

After such the operation at S5, both the braking time of the transportation vehicle ahead 13 as well as the braking time of the ego transportation vehicle 12 are available, wherein the latter relates to the braking time that the ego transportation vehicle 12 would need to come to a standstill in the same position as the transportation vehicle ahead 13 and by this means presumably avoid a collision.

On this basis, a comparison of the respective braking times can be carried out in operation at S6. It is more specifically determined which of the braking times is greater.

If the braking time up to the reaching of the standstill position, i.e., the collision avoidance position of the transportation vehicle ahead 13, is greater (i.e., that of the ego transportation vehicle 12 is smaller), it would (for example, based on an extrapolation of the current captured motional variables) be hit by the ego transportation vehicle 12 before it reaches the standstill position. Accordingly, a deceleration according to the above equation (5) would be chosen as the target deceleration of the ego transportation vehicle 12. It should be noted here that, according to the above reasoning, braking times necessary for reaching the collision-avoiding standstill position are considered as the basis for the target deceleration selection. In illustrative terms, the foundation here is thus a point in time or position of collision avoidance and not the potential collision itself, as is the case in approaches to date.

If the braking time of the transportation vehicle ahead 13 is smaller (i.e., that of the ego transportation vehicle 12 is greater), it would (based on an extrapolation of the current captured motional variables) reach the standstill position before the ego transportation vehicle 12. Accordingly, a deceleration according to the above equation (6) would be chosen as the target deceleration of the ego transportation vehicle 12.

The corresponding selection of the target deceleration according to operation at S6 occurs at a point in time that is as early as possible. However, it can be provided, as is standard in the prior art, to return to the operation at 51 during the executed emergency braking operation and to verify the selection of the target deceleration using continuously updated motional variables (see dashed arrow in FIG. 2).

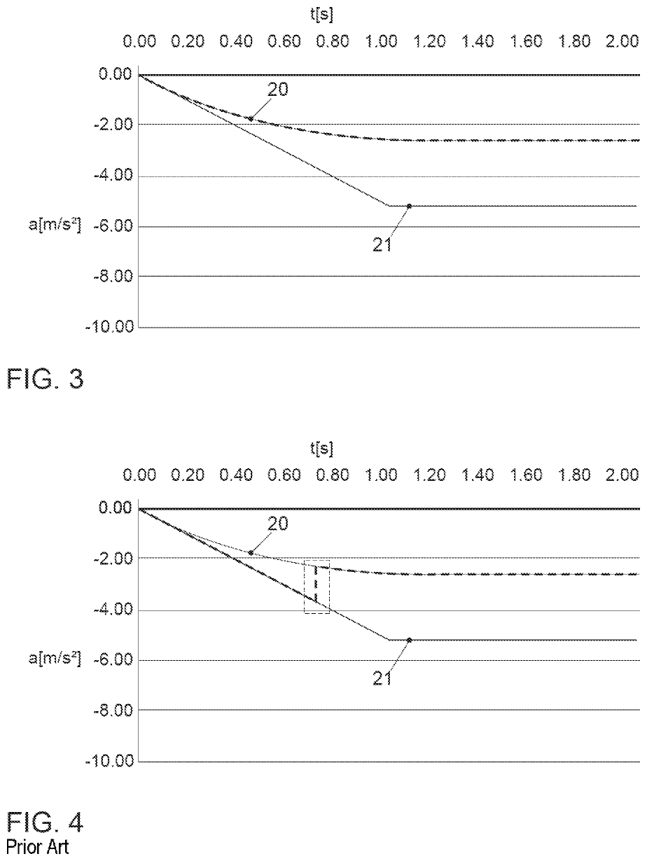

However, if it becomes evident from the achievable courses of deceleration shown in FIG. 3, the selection criterion for the target deceleration makes it possible that a target deceleration, once set, is maintained during the braking operation so that a constant course of deceleration results over time.

More precisely, the upper curve 20 in FIG. 3 relates to the deceleration based on the equation (5) (i.e., the case where the ego transportation vehicle 12 reaches the standstill position before the transportation vehicle ahead 13), while lower curve 21 relates to the deceleration based on the equation (6) (i.e., the case where the ego transportation vehicle 12 reaches the standstill position after the transportation vehicle ahead 13). For the selection of the target deceleration (i.e., whether the equation (5) or the equation (6) should be selected) based on the comparison of the braking times in relation to the standstill position, it has proven that, even when there is a continuously reiterated verification in relation to the target deceleration to be selected, no switches between the curves 20, 21 occur, but rather that a braking action, once started, is maintained in accordance with one of these curves 20, 21.

This becomes clear with the actually performed course of deceleration shown in FIG. 3, which is illustrated as a dashed line and extends continuously along only one of the curves 20, 21. It should be mentioned that the reason for this is the consideration of the collision-avoidance points in time as the starting point through a determination of the collision-avoiding standstill position.

By contrast, FIG. 4 shows the emerging courses of deceleration according to the prior art. Analogously to FIG. 3, upper and lower curves 20, 21 indicated as dashed lines are also present in this case. An actually performed course of deceleration is indicated as a dashed line. It can be observed that a deceleration is initially performed along the lower curve 21, but switches to the upper curve 20 after approx. 0.7 seconds. The reason is that the continuously executed comparison of the continuously determined eTTC discussed above and the continuously determined deceleration of the transportation vehicle ahead leads to a different conclusion regarding the collision scenario as of this point in time. This is expressed as a jump between the curves 20, 21 and generally as an inconstant course of deceleration.

This can be unexpected from the point of view of the driver and generally represents a safety risk, in particular, when the braking action is initially too weak or too strong. In the latter case, the following traffic would be placed at risk or an emergency braking function could be triggered without actually being necessary. As illustrated, such behavior can, however, be avoided by the solution proposed.

### LIST OF REFERENCES

Object_Time_to Stillstand Braking time of the transportation vehicle ahead
v_{Obj} Speed of the transportation vehicle ahead
a_{AbsObj} Value of the acceleration of the transportation vehicle ahead
Object_Distance_to Stillstand Braking distance of the transportation vehicle ahead
dx_rel Relative distance
Ego_Distance_to Stillstand Braking distance of ego transportation vehicle
Ego_Time_to Stillstand Braking time of ego transportation vehicle
D_{req,D} Emerging target deceleration (collision with moving transportation vehicle to be assumed),
D_{obs} Absolute deceleration of the transportation vehicle ahead,
v_{diff} Difference in speed between the ego transportation vehicle and the transportation vehicle ahead,
d Distance between the ego transportation vehicle and the transportation vehicle ahead,
D_{req,stop} Emerging target deceleration (collision with moving transportation vehicle to be assumed),
v_{sub} Speed of the ego transportation vehicle,
v_{obs} Speed of the transportation vehicle ahead,
10 Apparatus,
12 Transportation vehicle,
13 Transportation vehicle ahead,
14 Motional variable determination device,
15 Speed sensor,
16 Target deceleration definition device.

1. An apparatus for defining a target deceleration for an ego transportation vehicle, the apparatus comprising:
a motional variable determination device configured to determine at least one motional variable of a transportation vehicle ahead of the ego transportation vehicle on a roadway;
a target deceleration definition device adapted to determine:
a braking time and a braking distance based on the motional variable which the transportation vehicle ahead respectively requires to come to a standstill,
a latest braking time for the ego transportation vehicle that is required to come to a standstill at the same position as the transportation vehicle ahead when the transportation vehicle ahead has travelled the braking distance, and
a definition of target deceleration for the ego transportation vehicle based on a relationship of the braking times of the transportation vehicle ahead and the ego transportation vehicle.

2. A transportation vehicle comprising the apparatus of claim 1.

3. The apparatus of claim 1, wherein a first target deceleration is selected in response to the braking time of the transportation vehicle ahead being greater than the braking time of the ego transportation vehicle.

4. The apparatus of claim 3, wherein the first target deceleration relates to a collision scenario between the ego transportation vehicle and a still moving transportation vehicle ahead.

5. The apparatus of claim 3, wherein the following is selected as the first target deceleration:
$${D}_{req , D} = {D}_{obs} + \frac{{v}_{diff}^{2}}{2 d} ,$$
where D_{req,D} is the target deceleration to be set, D_{obs} is the absolute deceleration of the transportation vehicle ahead, v_{diff} is the difference in speed between the ego transportation vehicle and the transportation vehicle ahead and d is the distance between the ego transportation vehicle and the transportation vehicle ahead.

6. The apparatus of claim 1, wherein, a second target deceleration is selected in response to the braking time of the transportation vehicle ahead is smaller than the braking distance of the ego transportation vehicle.

7. The apparatus of claim 6, wherein the second target deceleration relates to a collision scenario between the ego transportation vehicle and a stationary transportation vehicle ahead.

8. The apparatus of claim 6, wherein the following is selected as the second target deceleration:
$${D}_{req , stop} = \frac{{v}_{sub}^{2}}{2 ( d + \frac{{v}_{obs}^{2}}{2 {D}_{obs}} )} ,$$
where D_{req,stop} is the target deceleration to be set, v_{sub} is the speed of the ego transportation vehicle, v_{obs} is the speed of the transportation vehicle ahead and d is the distance between the ego transportation vehicle and the transportation vehicle ahead.

9. A method for defining a target deceleration for an ego transportation vehicle, the method comprising:
determining at least one motional variable of a transportation vehicle ahead of the ego transportation vehicle on a roadway;
determining a braking time and a braking distance based on the motional variable which the transportation vehicle ahead respectively requires to come to a standstill,
determining a latest braking time for the ego transportation vehicle that is required to come to a standstill at the same position as the transportation vehicle ahead when the transportation vehicle ahead has travelled the braking distance, and
defining target deceleration for the ego transportation vehicle based on a relationship of the braking times of the transportation vehicle ahead and the ego transportation vehicle.

10. The method of claim 9, wherein a first target deceleration is selected in response to the braking time of the transportation vehicle ahead being greater than the braking time of the ego transportation vehicle.

11. The method of claim 10, wherein the first target deceleration relates to a collision scenario between the ego transportation vehicle and a still moving transportation vehicle ahead.

12. The method of claim 10, wherein the following is selected as the first target deceleration:
$${D}_{req , D} = {D}_{obs} + \frac{{v}_{diff}^{2}}{2 d} ,$$
where D_{req,D} is the target deceleration to be set, D_{obs} is the absolute deceleration of the transportation vehicle ahead, v_{diff} is the difference in speed between the ego transportation vehicle and the transportation vehicle ahead and d is the distance between the ego transportation vehicle and the transportation vehicle ahead.

13. The method of claim 9, wherein, a second target deceleration is selected in response to the braking time of the transportation vehicle ahead is smaller than the braking distance of the ego transportation vehicle.

14. The method of claim 13, wherein the second target deceleration relates to a collision scenario between the ego transportation vehicle and a stationary transportation vehicle ahead.

15. The method of claim 13, wherein the following is selected as the second target deceleration:
$${D}_{req , stop} = \frac{{v}_{sub}^{2}}{2 ( d + \frac{{v}_{obs}^{2}}{2 {D}_{obs}} )} ,$$
where D_{req,stop} is the target deceleration to be set, v_{sub} is the speed of the ego transportation vehicle, v_{obs} is the speed of the transportation vehicle ahead and d is the distance between the ego transportation vehicle and the transportation vehicle ahead.
